(19) United States
(12) Patent Application Publication
(10) Pub. No.: US 2019/0225741 A1
(43) Pub. Date: Jul. 25, 2019

(54) Electrical Insulation System Based on Epoxy Resins for Generators and Motors

(71) Applicants: Huntsman Advanced Materials Licensing (Switzerland) GmbH, The Woodlands, TX (US); ISOVOLTA AG, Wiener Neudorf (AT)

(72) Inventors: Christian Beisele, Müllheim (DE); Daniel Baer, Riehen (CH); Harald Stecher, Skoerping (DK)

(21) Appl. No.: 16/335,457

(22) PCT Filed: Sep. 25, 2017
(86) PCT No.: PCT/EP2017/074173

§ 371 Date: Mar. 21, 2019

(30) Foreign Application Priority Data
Sep. 28, 2016 (EP) 16191081.5

(51) Int. Cl. C08G 59/24; C08G 59/50; C08G 59/22; H01B 3/04; H01B 3/40; H02K 15/12

(52) U.S. Cl. CPC C08G 59/245; C08G 59/5093; H02K 15/12; H01B 3/04; H01B 3/40; C08G 59/226

(57) ABSTRACT

Disclosed is an anhydride-free insulation system for current-carrying construction parts of an electric engine which comprises:
(A) a mica paper or mica tape for wrapping parts of said electric engine that are potentially current-carrying during operation of the engine, which mica paper or mica tape is impregnable via vacuum pressure impregnation with a thermally curable epoxy resin formulation and comprises a complex of boron trihalogenide with an amine of the formula

BX₃·NR¹R²R³ or R¹R²N—A—NR¹R²,
wherein X denotes halogen,
R¹, R² and R³ are each independently of the others hydrogen, C₁-C₁₂alkyl, C₅-C₃₀aryl, C₆-C₃₆aralkyl or C₆-C₁₄cycloalkyl, which can be unsubstituted or substituted by one or more C₁-C₁₂alkyl groups,
A is a bivalent aliphatic aromatic or cycloaliphatic radical;
(B) a thermally curable bath formulation for the vacuum pressure impregnation comprising bisphenol A diglycidyl ether and optionally bisphenol F diglycidyl ether,
which formulation is substantially or, preferably, entirely free of thermally activatable curing initiators for the epoxy resin formulation.

### FIELD OF THE INVENTION

The present invention relates to a novel electrical insulation system for vacuum pressure impregnation of electrical machines, in particular large electrical machines, which insulation system is based on a thermally curable epoxy resin. The invention further relates to a specific mica paper or mica tape for use with said insulation system and to the use of said insulation system in the manufacture of rotors or stators of electrical generators or motors.

### BACKGROUND

Electrical engines, such as generators used for power plants or large electrical motors, contain current-carrying parts, e.g. wires and/or coils, that need to be electrically insulated against each other and/or against other electroconductive parts of the engine with which they would otherwise have direct contact. In medium or high voltage engines this insulation is typically provided by mica paper or mica tapes. After wrapping its current-carrying parts with the mica paper or mica tape, either the whole equipment or only a part thereof is impregnated with a curable, frequently epoxy-based, liquid resin formulation which also penetrates the mica paper or mica tape. This impregnation can advantageously be carried out using the so-called vacuum pressure impregnation (VPI) process. To this purpose the construction components of the engine, which shall be impregnated, are inserted into a container, which is then evacuated, so that humidity and air are removed from the gaps and voids of the components in the container including the gaps and voids in the mica paper or mica tape. Then an impregnation formulation is fed into the evacuated container followed by a period of applying an overpressure e.g. of dry air or nitrogen to the container containing the components, optionally under cautious heating in order to reduce the viscosity of the impregnation formulation sufficiently to allow an appropriate impregnation within a reasonable time, and said formulation penetrates the mica paper or tapes and the gaps and voids existing in the components forced by the pressure difference between the vacuum and the high pressure applied to the components. The residual impregnation formulation is thereafter removed from the container to a storage tank, optionally replenished with new formulation and stored, frequently under cooling, for its next use. The impregnated components are also removed from the container and thermally cured in order to mechanically fix the mica-wrapped current-carrying parts of the component to each other and/or to embed these parts or the entire component into an electrically insulating polymer mass. This cycle of impregnation of components and interim storage of the impregnation formulation until further use is normally repeated until the viscosity of the impregnation formulation increases to an extent that it can no longer penetrate the voids of the components sufficiently within a reasonable time for ensuring an appropriate electrical insulation after cure of the formulation.

There are several important aspects regarding the suitability of a material for a successful industrial vacuum pressure impregnation, particularly of large electrical engines or components thereof.

The viscosity of the impregnation formulation determines to a major extent the impregnation effectiveness and capability of the formulations. The lower the viscosity of the formulation the better and faster it can fill up gaps and voids in the impregnated component and in the mica paper or mica tape.

Furthermore, the afore-mentioned initial viscosity of the formulation, i.e. the viscosity of the formulation, when it is used for the first time, should increase only very slowly over time at the temperatures applied for the impregnation with the formulation and the storage of the formulation between subsequent uses, so that the formulation maintains a reasonable impregnation effectiveness and capability and must not be replaced with new formulation for a reasonably long time period, and this preferably without need to cool the formulation when it is not in use.

Contrary to this, the reactivity of the impregnation formulation should preferably be high at higher temperatures in order to ensure a fast curing of the formulation after impregnation.

The working hygiene, meaning the release of potentially harmful compounds to the working environment, is a further important aspect concerning the handling of an impregnation formulation.

The long-term thermal stability of the cured impregnation formulation, its electrical properties and its mechanical properties must furthermore be good to ensure a long endurance and life-time of the impregnated components of the engines.

A particularly important descriptor of electrical insulation systems based on polymers is the “thermal class” of the system or its cured polymer formulation, which classifies the system or its cured polymer formulation according to the maximum continuous working temperature applicable to the insulation system established for 20000 h of working life. Two particularly important thermal classes for medium sized and large electrical engines like motors or generators are “Class F” and “Class H” and permit a maximum attainable continuous use temperature of the cured insulation material of 155° C. and 180° C., respectively.

Another particularly important parameter of a cured electric insulation material is its dielectric dissipation factor tan δ□ which is a parameter quantifying the electric energy inherently lost to the insulation material, usually in form of heat, in an alternating electrical field. The tan δ corresponds at low δ values to the ratio of the electric power lost in the insulating material to the electric power applied and is therefore frequently expressed as a percentage, for example a tan δ□ of 0.1 corresponds to 10% according to this notation. Lower dissipation factors are thus indicative of lower losses of electrical power in the insulation material and are generally desirable in order to reduce the heating-up of the insulator material during operation and thus reduce its thermal decomposition and destruction. However, the permittivity ε and thus the dissipation factor are not only dependent on the chemical composition of the insulating material but also depend on several processing parameters, such as the degree of cure of the insulating material, its content of voids, moisture and impurities etc. The eventual permittivity ε and dissipation factor of an electric insulation material can thus neither be predicted nor controlled, they can only be determined on the finished insulation material. The dissipation factor of polymeric material for a given frequency increases with the temperature of the material. For ensuring a suitable insulation and preventing damage of the engines, it should generally be less than about 10%, even at the maximum permissible working temperature according to the thermal class of the material.

Due to their generally good over-all properties and characteristics, epoxy resin formulations are frequently used for the preparation of high quality insulation systems for electrical engineering.

The currently most widely used epoxy resin formulation for vacuum pressure impregnation insulation of electrical components is based on diglycidyl ethers of bisphenol A and/or bisphenol F and/or cycloaliphatic epoxy resins, methylhexahydrophthalic acid anhydride (MHHPA) or hexahydrophthalic acid anhydride (HHPA) as curing agent (hardener) and an appropriate curing catalyst (curing accelerator) such as e.g. zinc naphthenate. Insulations based on these anhydride-containing formulations are normally rated to be Class H-insulations. The anhydride hardener also contributes to quite a low initial viscosity and a very good impregnation effectiveness of these formulations even at or near room temperature.

Due to the developing regulatory framework for chemicals however, it is expected that the use of anhydride hardeners in epoxy resin formulations will be restricted in the near future, because of their R42 label as a respiratory sensitizer. Therefore, some anhydrides are already on the SVHC candidate list (substances of very high concern) of the REACH regulation. As all known anhydrides are R42-labeled and even yet unknown anhydrides are expected by toxicologists to become also R42-labeled, it is likely that in some years impregnation formulations based on epoxy resins and anhydride hardeners like those mentioned above may no longer be used without special authorisation.

Epoxy resin based formulations for vacuum pressure insulation which are free of anhydride hardeners are already known. For example, one component epoxy resin compositions based on bisphenol A diglycidyl ethers or bisphenol F diglycidyl ethers or mixtures thereof and a latent curing catalyst for homopolymerisation are on the marketplace, such as e.g. ARALDITE° XD 4410. Impregnation formulations like these have the additional advantage that the end user need not possess a mixing equipment on site for mixing the epoxy resin with the anhydride hardener, but on the other hand have the disadvantage that the impregnation bath has a rather high initial viscosity because the anhydride hardener is absent in these systems. Formulations of this kind therefore normally must be warmed-up to temperatures around 60° C. in order to achieve a sufficient impregnation effectiveness. Consequently, the increase of viscosity of these formulations during non-use is also comparably high.

Epoxy resins, whether hompolymerised or hardened with an anhydride hardener, generally require a latent catalyst, also called an accelerator, in order to cure. The term “latent” means that the accelerator is essentially inactive at temperatures up to the temperature needed upon impregnation of a component to be integrated, but will catalyse the curing at higher temperatures after completion of the impregnation. A well and long known latent accelerator is zinc naphthenate. The accelerator is preferably not included into the impregnating epoxy resin but into the component to be impregnated, such as a mica paper or mica tape (in an amount to ensure that sufficient curing catalyst is released during the impregnation step to that part of the formulation taken up by the component to be impregnated for allowing its efficient thermal cure after removal of the component from the residual formulation bath). In this case the increase in viscosity of such an impregnation bath over time can be kept within reasonable limits, because no or only marginal residual amounts of accelerator are present in the bath formulation before it comes into contact with the component to be integrated. Therefore, impregnation baths based on these accelerator-free formulations generally have a good shelf life. Nevertheless, these accelerator-free formulations may need cooling when they are not used.

In the publication “Traditional and New Epoxy Systems for Vacuum Pressure Impregnation of Electrical Machines” by two of the instant inventors, presented at the Insucon Conference of 19-31 May 2013 in Birmingham, UK, there is disclosed the use of BCl₃ as such or of an above amine complex thereof as accelerator in the curing of bisphenol-A-diglycidyl ether (=BADGE) which is hardened with methyl-hexahydrophthalic acid anhydride (=MHHPA). This publication discloses that distillation of BADGE and optionally also purification of MHHPA may improve the thermal stability at 23° C. of a VPI resin bath containing these.

U.S. Pat. No. 3,991,232 A discloses a mica tape coated with a varnish containing BF₃-amine complex salts as accelerator, and the vacuum impregnation of such tape using cyclo-aliphatic epoxy resins and anhydride hardener. The amine in the BF₃-amine complex may be monoethylamine, piperidine or benzylamine.

U.S. Pat. No. 3,395,121 A discloses addition products of boron trichloride and tertiary amines as latent curing agents for epoxy resins in homogeneous solution. The most preferred amine in the complex is trimethylamine. This publication compares the trimethylamine complex of BCl₃ and the monoethylamine complex of BF₃ in their curing properties in homogeneous epoxy systems.

Huntsman Advanced Materials advertises under the trade name DY 9577 the BCl₃-dimethyloctylamine complex as an accelerator for epoxy curing. The datasheet of DY 9577 discloses that DY 9577 can be used in homogeneous mixture to cure epoxy resins in the absence of anhydride hardener, when used in amounts of 1-5 parts by weight per 100 parts of resin.

So, there is still a need for improved anhydride-free epoxy resin insulation systems suitable in particular for vacuum pressure impregnation. It is therefore the objective of the present invention to provide such an insulation system having processing characteristics comparable to those of the above described current “gold standard”-systems for vacuum pressure impregnation based on liquid epoxy resins and anhydride hardeners, or even better properties, in particular in respect of impregnation effectiveness, storage stability, curing speed, achievable thermal conductivity and thermal class and the long-term thermal, mechanical and electrical properties including in particular a sufficiently low dielectric dissipation factor at all working temperatures permissible for Class F and Class H insulation systems.

It has now been found that the afore-mentioned objective is solved by an anhydride-free insulation system for current-carrying construction parts of an electric engine which comprises:
(A) a mica paper or mica tape for wrapping parts of said electric engine that are potentially current-carrying during operation of the engine, which mica paper or mica tape is impregnable via vacuum pressure impregnation with a thermally curable epoxy resin formulation and comprises a complex of boron trihalogenide with an amine of the formula

BX₃·NR¹R²R³ or R¹R²N—A—NR¹R²,
wherein X denotes halogen,
R¹, R² and R³ are each independently of the others hydrogen, C₁-C₁₂alkyl, C₅-C₃₀aryl, C₆-C₃₆aralkyl or C₆-C₁₄cycloalkyl, which can be unsubstituted or substituted by one or more C₁-C₁₂alkyl groups,
A is a bivalent aliphatic aromatic or cycloaliphatic radical;
(B) a thermally curable bath formulation for the vacuum pressure impregnation comprising bisphenol A diglycidyl ether and optionally bisphenol F diglycidyl ether,
which formulation is substantially or, preferably, entirely free of thermally activatable curing initiators for the epoxy resin formulation.

The amount of curing initiator in the epoxy resin formulation taken up by the mica paper or mica tape and the construction part of the engine during the vacuum pressure impregnation step depends on the nature of the epoxy resin bath formulation to be cured and the desired polymerisation conditions. Suitable amounts can be determined by a skilled person with a few pilot tests. Preferably said amount is between about 0.01 to about 15 weight percent, preferably between 0.05 to about 10 weight percent, more preferably between about 0.1 and about 5 weight percent, based on the epoxy resin, e.g. about 1 to about 3 weight percent.

Mica paper and mica tapes are well known in the art.

For the purposes of this invention the term mica paper is used in its usual sense to refer to a sheet-like aggregate of mica particles, in particular muscovite or phlogopite particles, which are optionally heated to a temperature of about 550 to about 850° C. for a certain time period (e.g. about 5 minutes to 1 hour) to partially dehydrate them and are ground into fine particles in an aqueous solution and then formed into a mica paper by conventional paper-making techniques. Optionally mica consolidation additives, e.g. dispersing agents, thickening agents, viscosity modifiers and the like as well as resins including inorganic resins such as e.g. boron phosphates or potassium borates and organic resins such as e.g. epoxy resins, polyester resins, acrylic resins or silicone resins can be added during the formation of the mica paper in order to improve or modify its properties.

The term mica tape as used in this application refers to a sheet-like composite material consisting of one or more layers of mica paper as described above which is (are) glued to a sheet-like carrier material, usually a non-metallic inorganic fabric such as glass or alumina fabric or polymer film such as polyethylene terephthalate or polyimide, using a small amount (about 1 to about 10 g/m² of mica paper) of a resin, preferably an epoxy or acrylic resin or a mixture thereof. The agglutination of the mica paper and the fabric is advantageously performed in a press or a calender at a temperature above the melting point of the adhesive resin.

The mica paper or the mica tape is then impregnated with a solution comprising the BX₃-amine complex in a suitable low-boiling solvent, such as propylene carbonate (PC) or methyl ethyl ketone (MEK), γ-butyro-lactone and the like or mixtures thereof.

Mica papers and mica tapes impregnated with a BX₃-amine complex are still novel and are therefore a further subject of the present invention.

For the preparation of mica papers or mica tapes according to the invention the BX₃-amine complex for the homopolymerisation of epoxy resins or a mixture of such initiators are e.g. dissolved in a suitable low-boiling solvent, such as propylene carbonate or methyl ethyl ketone and the like. The mica paper or mica tape is contacted with said solution, e.g. by immersion therein or by spraying, and the solvent removed to leave the BX₃-amine complex on and/or inside the structure of the mica paper or tape. The concentration of BX₃-amine complex in the impregnation solution is not critical and can, for instance, vary between e.g. about 0.1 and about 25 percent by weight of BX₃-amine complex. The higher the concentration of BX₃-amine complex, the higher is the final load of the mica paper or mica tape achieved during an impregnation step.

The mica paper or mica tape according to the invention must contain the BX₃-amine complex in an amount sufficient to cure the epoxy resin taken up by the mica paper or mica tape and eventually by the construction part of the engine during the vacuum pressure impregnation.

It has been found by the inventors that the ratio R of the weight of BX₃-amine complex (m_{acc}, in grams) to the weight of epoxy-containing impregnation bath (m_{bath}, in grams), if the BX₃-amine complex is absorbed onto or impregnated into the mica tape, is preferably in the range of 0.01 to 0.10:

$$0.01 \leq R ≡ \frac{{m}_{a cc}}{{m}_{bath}} = \frac{{m}_{acc} / {m}^{2}}{{m}_{bath} / {m}^{2}} \leq 0.10 \qquad ( 1 )$$

wherein the symbols are as defined above. According to formula (1) an area A of mica paper or mica tape containing a given amount m_{acc} of BX₃-amine complex per square meter of its surface may contain “sufficient” BX₃-amine complex to typically cure under usual cure conditions, such as 170° C. for 12 h and 20 bar pressure, an amount m_{bath} of epoxy-containing impregnation which is

100A×m_{acc}/m²≥m_{bath}≥10A×m_{acc}/m² (2)

wherein all symbols are as defined above and said amount of m_{bath} of epoxy-containing impregnation preferably adhering to and/or being impregnated into that area A of mica paper or mica tape.

Alternatively the above mentioned R can also be expressed as follows:

$$R = \frac{{m}_{acc}}{{m}_{bath}} = \frac{{m}_{acc} / {m}^{2}}{{m}_{bath} / {m}^{2}} = \frac{M {W}_{acc}}{{EEW}_{bath}} \times \frac{ r mol accelerator / {m}^{2}}{1 mol epoxy / {m}^{2}} = \frac{M {W}_{acc}}{{EEW}_{bath}} \times \frac{r mol accelerator}{1 mol epoxy} \qquad ( 3 )$$

wherein MW_{acc} is the molecular weight of the BX₃-amine complex (in grams/mol) present in the mica tape or mica paper, EEW_{bath} is the epoxide equivalent weight of the epoxy-containing impregnation bath (in grams/mol), and the rightmost quotient appearing in (3) is the number r of moles of BX₃-amine complex used to cure 1 mol epoxy moieties. The inventors have furthermore found that, if the BX₃-amine complex is according to the invention absorbed onto or impregnated into the mica tape or mica paper, said rightmost quotient appearing in (3) is preferably in the range of 0.01 to 0.025. According to formula (3) an area A of mica paper or mica tape containing a given amount m_{acc} of BX₃-amine complex per square meter of its surface may contain “sufficient” BX₃-amine complex to typically cure under usual cure conditions, such as 170° C. for 12 h and 20 bar pressure, an amount m_{bat}h of epoxy-containing impregnation which is

$$\frac{1}{0.025} A \times {m}_{a cc} / {m}^{2} \times \frac{{EEW}_{bath}}{M {W}_{acc}} \leq {m}_{bath} \leq \frac{1}{0.01} A \times {m}_{a cc} / {m}^{2} \times \frac{{EEW}_{bath}}{M {W}_{acc}} \qquad ( 4 )$$

wherein all symbols are as defined above, and said amount of m_{bath} of epoxy-containing impregnation preferably adhering to and/or being impregnated into that area A of mica paper or mica tape.

For this purpose, the mica paper or mica tape preferably comprises the BX₃-amine complex in an amount of about 0.01 to about 100 g/m² of the mica paper or mica tape, preferably about 2 to about 50 g/m², more preferably about 2.0 to about 20 g/m².

BX₃-amine complexes are purposively BF₃- and BCl₃-amine complexes. BF₃- and BCl₃-amine complexes are known and to some extent commercially available.

Examples for suitable BF₃-amine complexes are BF₃-aniline complex, BF₃-2,4dimethylaniline complex, BF₃-benzylamine complex, BF₃-dibutylamine complex, BF₃-ethylamine complex, BF₃-isopropylamine complex, BF₃-N-methylcyclohexylamine complex, BF₃-piperidine complex and BF₃-isophorone diamine complex,

Preferably, the BX₃-amine complex is BCl₃·N(CH₃)₃ (boron trichloride-trimethyl amine complex) or BCl₃·N(CH₃)₂C₈H₁₇ (boron trichloride-dimethyl octyl amine complex)(I-2).

The epoxy resins of the thermally curable bath formulation for the vacuum pressure impregnation may in principle comprise, further to the bisphenol A diglycidyl ether and optional bisphenol F diglycidyl ether, any mono- or polyepoxy compound which is liquid at ambient or moderately elevated temperatures such as from about 20 to about 60° C. These polyepoxy compounds thus act as reactive diluents. Illustrative examples of suitable mono- and polyepoxy compounds are:

Some suitable examples are: tolylglycidyl ether, p-tert.-butyl-phenylglycidyl ether, n-dodecyl-/n-tetradecylglycidyl ether, 1,4-butanedioldyglycidyl ether, 1,6-hexanediol-diglycidyl ether, trimethylolpropanetriglycidyl ether, polyglycidyl ether like polyoxypropylenediglycidyl ether, cyclohexane-dimethanoldiglycidyl ether, glycidylester of neodecanoic acid and of cyclohexanedicarboxylic acid.
A) Monoglycidyl ethers like 2-ethylhexylglycidyl ether, cresylglycidyl ether, p-tert.-butyl-phenylglycidyl ether, n-dodecyl-/n-tetradecylglycidyl ether and C₁₀-C₁₆alkylglycidyl ether.
B) Polyglycidyl ethers derived from epichlorohydrin and phenolic compounds other than bisphenol A and bisphenol F, such as mononuclear phenols, typically resorcinol or hydroquinone, 2,2-bis(3,5-dibromo-4-hydroxyphenyl)propane, 1,1,2,2-tetrakis-(4-hydroxyphenyl)ethane as well as from novolacs obtainable by condensation of aldehydes such as formaldehyde, acetaldehyde, chloral or furfuraldehyde, with phenols such as preferably phenol or cresol, or with phenols which are substituted in the nucleus by chlorine atoms or C₁-C₉alkyl groups, for example 4-chlorophenol, 2-methylphenol or 4-tert-butylphenol.
C) Diglycidylethers derived from epichlorohydrin and acyclic alcohols, typically from ethylene glycol, diethylene glycol and higher poly(oxyethylene) glycols, 1,2-propanediol or poly(oxypropylene) glycols, 1,3-propanediol, 1,4-butanediol, poly(oxytetramethylene) glycols, 1,5-pentanediol, 1,6-hexanediol, 2,4,6-hexanetriol, glycerol, 1,1,1-trimethylolpropane, pentaerythritol, sorbitol, as well as from polyepichlorohydrins. They may also be derived from cycloaliphatic alcohols such as 1,3- or 1,4-dihydroxycyclohexane, 1,4-cyclohexanedimethanol, bis(4-hydroxycyclohexyl)methane, 2,2-bis(4-hydroxycyclohexyl)propane or 1,1-bis(hydroxymethyl)cyclohex-3-ene, or they contain aromatic nuclei such as N,N-bis(2-hydroxyethyl)aniline or p,p′-bis(2-hydroxyethylamino)diphenylmethane.
D) Cycloaliphatic epoxy resins comprising at least two oxirane rings fused to a cycloaliphatic ring in the molecule of the epoxy. Preferred examples include resin like e.g diepoxides of dicyclohexadiene or dicyclopentadiene, bis(2,3-epoxycyclopentyl)ether, 1,2-bis(2,3-epoxycyclopentyloxy)ethane, 3,4-epoxycyclohexyl-3′,4′-epoxycyclohexanecarboxylate and 3,4-epoxycyclohexylmethyl-3′,4′-epoxycyclohexanecarboxylate (commercially available as ARALDITE®CY 179-1 from Huntsman, Switzerland).

In one particularly preferred embodiment the thermally curable bath formulation for the vacuum pressure impregnation (B) comprises, or consists essentially of, diglycidyl ethers of bisphenol A having the formula:

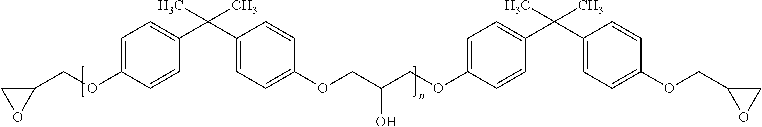

wherein n is a number equal or greater than zero, in particular 0 to 0.3, and represents an average over all molecules.

In another particularly preferred embodiment the thermally curable bath formulation for the vacuum pressure impregnation (B) comprises, further to diglycidyl ethers of bisphenol A as described immediately above, diglycidyl ethers of bisphenol F having the formula:

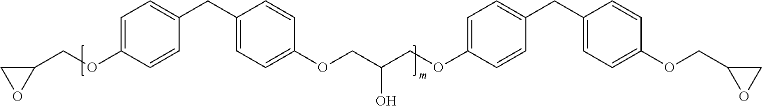

wherein m may be 0 to 0.3, but may also be higher, such as 0.3 to 0.5, and represents an average over all molecules. The amount of the further diglycidyl ethers of bisphenol F may be from 0 to 30 wt %, based on the overall thermally curable bath formulation for the vacuum pressure impregnation (B). More preferably here again, the thermally curable bath formulation for the vacuum pressure impregnation (B) consists essentially of diglycidyl ether of bisphenol A and diglycidyl ether of bisphenol F.

The lower the indexes n and m are, the lower is the viscosity of these resins. For the purposes of the present invention at least n is therefore preferably equal to zero or substantially equal to zero, e.g. in the range of 0 to 0.3 corresponding to about 5.85 epoxy equivalents per kg bisphenol A diglycidyl ether resin to about 4.8 epoxy equivalents per kg bisphenol A diglycidyl ether resin. If m is equal to zero or substantially equal to zero, e.g. in the range of 0 to 0.3, then this corresponds to about 6.4 epoxy equivalents per kg bisphenol F diglycidyl ether resin to about 5.3 epoxy equivalents per kg bisphenol A diglycidyl ether resin.

Mostly preferred in this embodiment the diglycidyl ethers of bisphenol A are obtainable by distillation of corresponding raw diglycidyl ethers, wherein n is substantially equal to zero such as bisphenol A diglycidylether resins with about 5.7 to 5.9 epoxy equivalents per kg or bisphenol F diglycidylether resins with about 6.0 to 6.4 epoxy equivalents per kg. The distilled diglycidylethers of bisphenol A furthermore comprise generally a reduced quantity of other side products and/or impurities and have therefore normally an improved shelflife.

In another particularly preferred embodiment the thermally curable bath formulation comprises diglycidyl ethers of bisphenol A of the above formula, but wherein n is significantly greater than zero, such as 0.3 to 1.5. This corresponds to a mixture of diglycidyl ethers of bisphenol A containing significant amounts of higher homologues, besides the lowest homologue with n=exactly zero.

In one alternate preferred embodiment the thermally curable bath formulation comprises the sum of bisphenol A diglycidyl ether and optional bisphenol F diglycidyl ether and the sum of reactive diluents in a weight ratio from about 10:1 to about 3:1, more preferably from about 10:1 to about 5:1.

The viscosity of the epoxy resin bath formulation according to the invention does preferably viscosity not exceed about 75 mPa.s at 60° C., more preferably not exceed about 50 mPa.s at 60° C.

The epoxy resins of the thermally curable epoxy bath according to the present invention provide, on one hand, a very low viscosity at room temperature or moderately elevated temperatures of about 20° C. to about 60° C. and result, on the other hand, when thermally cured with a curing initiator/co-initiator system according to the present invention, in a cured insulation material of insulation class F or H, i.e. permit a maximum continuous use temperature of 155° C. and 180° C., respectively, which insulation material furthermore exhibits excellent dielectric dissipation factors (tan δ□ being significantly below 10% at 155° C.

The thermally curable bath formulation for vacuum pressure impregnation (B) according to the invention may optionally furthermore comprise additives for improving the properties of the thermally curable epoxy bath formulation and/or the cured insulation material derived therefrom, such as tougheners or aids for improving the thermal conductivity of the cured insulation material such as micro and/or nano particles selected from the group consisting of metal or semi-metal oxides, carbides or nitrides and wetting agents therefore, as long as these agents are used in amounts that do not have a negative impact on the properties of the epoxy bath formulation before cure, like e.g. on its shelflife or viscosity, and/or on essential properties of the finally obtained cured insulation material, in particular on its dielectric dissipation factor and on its thermal classification.

Suitable tougheners for the purposes of the present invention include e.g. reactive liquid rubbers such as liquid amine- or carboxyl-terminated butadiene acrylonitrile rubbers, dispersions of core-shell rubbers in low viscosity epoxy resins as commercially available e. g. under the tradename Kane Ace™ MX.

Suitable metal or semi-metal oxides, carbides or nitrides include e.g. aluminum oxide (Al₂O₃), titanium dioxide (TiO₂), zinc oxide (ZnO), cerium oxide (CeO₂), silica (SiO₂), boron carbide (B₄C), silicon carbide (SiC), aluminium nitride (AlN) and boron nitride (BN) including cubic boron nitride (c-BN) and particularly hexagonal boron nitride (h-BN), which may optionally be surface-modified in a known way, e.g. by treatment with γ-glycidyloxypropyltrimethoxysilane, to improve the interface and adhesion between the filler and the epoxy matrix. Mixtures of metal, semi-metal oxides, carbides and/or nitrides can of course also be used.

Particularly preferred are metal and semi-metal nitrides, in particular aluminium nitride (AlN) and boron nitride (BN), in particular hexagonal boron nitride (h-BN).

Micro particles are understood for the purposes of this application to include particles of an average particle size of about 1 μm or more, provided that the filler particles can still penetrate the mica tape and the gaps and voids of the construction part to be impregnated. Preferably the micro particles have a so-called volume diameter D(v)50 of up to about 10 μm, more preferably from about 0.1 to about 5 μm, in particular about 0.1 to about 3 μm, e.g. about 0.5 to 1 μm, wherein a volume diameter D(v)50 of x μm specifies a filler sample wherein 50% of the volume of its particles have a particle size of equal or less than x μm and 50% a particle size of more than x μm. D(v)50 values can e.g. be determined by laser diffractometry.

Micro particles, in particular when present for improvement of the thermal conductivity of the insulation material, are preferably added in amounts of 2 to about 60% by weight based on the total weight of the thermally curable epoxy resin formulation according to the invention, more preferably in amounts of about 5 to about 40% by weight, in particular about 5 to about 20% by weight.

Nano particles are understood for the purposes of this application to include particles of an average particle size of about 100 nm or less, Preferably the nano particles have a volume diameter D(v)50 of up to about 10 to about 75 nm, more preferably from about 10 to about 50 nm, in particular about 15 to about 25 nm, e.g. about 20 nm.

Nano particles are typically used in smaller quantities than micro particles, because in larger amounts they sometimes tend to raise the bath viscosity more than a similar amount of microparticles. Suitable amounts of nano particles preferably range from about 1 up to about 40% by weight based on the total weight of the thermally curable epoxy resin formulation according to the invention, more preferably from about 5 to about 20% by weight, in particular from about 5 to about 15% by weight.

Micro and nano particles can also be used together in admixture.

Preferably, micro and nano particles are surface modified to make them more compatible with the epoxy resins, e.g. surface-treated with γ-glycidyloxypropyltrimethoxysilane, or are used in combination with a wetting agent for said purpose.

In a particularly preferred embodiment of the insulation systems according to the invention the thermally curable epoxy bath formulation (B) comprises micro particles, nano particles or a mixture thereof, preferably nano particles, which particles are selected from metal or semi-metal oxides, carbides or nitrides, in particular from metal or semi-metal carbides or nitrides and, optionally, a wetting agent.

The thermally curable epoxy bath formulation (B) is preferably, entirely free of thermally activatable curing initiators for the epoxy resin formulation. This includes freedom of BX₃-amine complex as described above; it also includes freedom of prior art accelerators such as Zn-naphthenate, tertiary amines, or sulfonium salts. “Freedom” from any of these accelerators shall mean less than 0.1% by weight for each such accelerator, based on thermally curable epoxy bath formulation (B).

The insulation systems according to the invention are particularly suitable for use in the manufacture of rotors or stators of electrical generators or motors, in particular of large generators or motors. This use is therefore another subject of the invention.

The electrical insulation systems according to the invention can e.g. be used in the manufacture of rotors or stators of electrical generators or motors according to a process, wherein
(a) the potentially current-carrying parts of the rotor or stator or the construction part thereof are wrapped with a/the mica paper or mica tape which is impregnable via vacuum pressure impregnation with a thermally curable epoxy resin formulation and comprises a complex of BX₃ with a tertiary amine as defined above, which is contained by said mica tape in an amount sufficient to cure the epoxy resin taken up by the mica tape and the construction part of the engine during a vacuum pressure impregnation step,
(b) the rotor or stator or the construction part thereof is inserted into a container,
(c) the container is evacuated,
(d) a thermally curable bath formulation for the vacuum pressure impregnation as defined above, is fed into the evacuated container followed by a period of applying an overpressure e.g. of dry air or nitrogen to the container containing the rotor or stator or the construction part thereof, optionally under cautious heating in order to reduce the viscosity of the thermally curable bath formulation in the container sufficiently to allow that said formulation penetrates said mica tape and the gaps and voids existing in the structure of the rotor or stator or the construction part thereof within a desired time period forced by the pressure difference between the vacuum and the high pressure applied to the components,
(e) the residual thermally curable bath formulation is removed from the container, and
(f) the rotor or stator or the construction part thereof, impregnated with the thermally curable bath formulation, is removed from the container and heated after removal from the container in order to cure the thermally curable bath formulation comprised by said rotor or stator or the construction part thereof.

A corresponding process for using an anhydride-free insulation system according to the invention is a further subject of the invention.

The length of the period of applying the overpressure to the container can be chosen by a skilled person depending e.g. on the viscosity of the thermally curable bath formulation, the structure and impregnability of the mica paper or mica band used, the size of the rotor or stator or the construction part thereof, which shall be impregnated, and the complexity of their construction and ranges preferably between about 1 and about 6 hours.

For performing the cure of the thermally curable bath formulation comprised by the rotor or stator or the construction part thereof, they are heated. The curing temperature depends on the epoxy resin formulation applied and the specific sulfonium salt initiator(s) applied and ranges generally from about 60 to about 200° C., preferably from about 80 to about 160° C.

In an especially preferred embodiment of the above process for using the insulation systems according to the invention in the manufacture of rotors, stators or construction parts thereof the thermally curable bath formulation is fed into the evacuated container from a storage tank and is returned to said storage tank again after removal from the container and is stored in the tank, optionally under cooling, for further use. Before further use the used bath formulation can be replenished with new formulation.

In a further aspect the present invention relates to mica papers or the mica tapes for use with insulation system described above, which are impregnable via vacuum pressure impregnation with a thermally curable epoxy resin formulation and comprise one or more thermally activatable sulfonium salt initiators for the homopolymerisation of epoxy resins.

Preferably, said mica papers or mica tapes comprise the BX₃-amine complex in an amount of about 0.01 to about 100 g/m² of the mica paper or mica tape, preferably about 2.0 to about 50 g/m², more preferably about 2.0 to about 20 g/m².

Preferred embodiments of the mica papers or mica tapes according to the invention include BCl₃·N(CH₃)₃ (boron trichloride-trimethyl amine complex) or BCl₃·N(CH₃)₂C₈H₁₇ (boron trichloride-dimethyl octyl amine complex).

The flexibility of the inventive tapes may be increased, if desired, by using additional consolidating resins or additives as have been known for prior art mica tapes.

### EXAMPLES

The following Examples serve to illustrate the invention. Unless otherwise indicated, the temperatures are given in degrees Celsius, parts are parts by weight and percentages relate to percent by weight (weight percent). Parts by weight relate to parts by volume in a ratio of kilograms to litres.

(A) Description of ingredients used in the Examples:

| | |
|---|---|
| MY 790-1 CH: | distilled bisphenol A diglycidyl ether (BADGE), epoxy |
| | eq.: 5.7-5.9 eq./kg, supplier: Huntsman, Switzerland; |
| PY 306 | bisphenol F diglycidyl ether (BFDGE), epoxy eq.: |
| | 6.0-6.4 eq./kg, supplier: Huntsman, Switzerland; |
| GY 250 | undistilled BADGE, epoxy eq.: 5.3-5.45 eq/kg, supplier: |
| | Huntsman, Switzerland; |
| DY 023 | 2,3-Epoxypropyl o-tolylether, reactive diluent, supplier: |
| | Huntsman, Switzerland |
| HY 1102: | methylhexahydrophthalic acid anydride (MHHPA), |
| | supplier: Huntsman, Switzerland; |
| XD 4410: | one-component epoxy-based VPI-resin based on BADGE, |
| | BFDGE and 2,3-epoxypropyl-o-tolylether, contains highly |
| | latent accelerator, supplier Huntsman, Switzerland; |
| DY 9577: | Neat borontrichloride-dimethyloctylamine complex (1:1), |
| | supplier: Huntsman, Switzerland; |
| EP 455 | Neat borontrichloride-trimethylamine complex (1:1), |
| | supplier: Syntor, UK |
| PC: | Propylene-carbonate: supplier: Huntsman |

Mica tapes are composed of mica paper, optionally containing one or more additives or resins for consolidation of the mica paper, and a light-weight glass fabric made from E-glass or a polymer film that is adhered to the mica paper with a non-reactive or reactive adhesive for mechanical support. Following reference mica tapes were used in the Examples: Poroband ME 4020: mica tape containing zinc naphthenate, supplier: Isovolta, Austria; Poroband 0410: mica tape without accelerator, supplier: Isovolta, Austria.

Preparation of Mica Paper and Mica Tapes According to the Invention and Application Tests Thereof:

(C1) Mica tape with boron trichloride-dimethyl octyl amine complex as the BX₃-amine complex

A mica paper sheet based on uncalcined mica flakes with an areal weight of 160 g/m² was cut in a rectangular shape of the size 200×100 mm. For mica paper impregnation a solution of DY 9577) in methyl ethyl ketone (MEK) was prepared which contained 3 wt % of DY 9577. The mica sheets were impregnated with 2.0 g of the solution and the solvent was removed in an oven at 120° C. for 3 min. The mica paper thus prepared contained 3 g/m² boron trichloride-dimethyl octyl amine complex. Additionally, the mica sheets were impregnated either in the same step or in a second step with a consolidation resin. For the consolidation resin a 5% solution of polyol, polyester or modified polyester and/or polyol was prepared in MEK. The mica sheets were impregnated with 1.6 g of this solution. The solvent was removed in an oven at 120° C. for 3 min resulting in 4 g/m² consolidation resin (polyol, polyester or a modified polyester and/or polyol).

The treated mica paper was used in combination with a glass fabric style 792 (23 g/m², 26×15, 5.5 tex/5.5 tex).

In one alternative the glass fabric was previously coated with 6 to 8 g/m² of a polyester, polyol or polyester/polyol resin mixture. The coated glass was laid on top of the treated mica paper and laminated in a moulding device at 130° C. for 30 s. A mica tape was obtained which is designated in the following as (C1-1).

In another alternative the glass fabric, was previously coated with 3 g/m² of an epoxy/acrylic resin mixture. The coated glass fabric was adhered to the mica tape using a solid epoxy resin having a melting point around 100° C. For this purpose the solid epoxy resin was evenly dispersed on the treated mica paper. Then the glass fabric was laid on top. The specimen was put into a heated press to melt the epoxy resin (130° C. for 30 s). A mica tape was obtained which is designated in the following as (C1-2).

In either of the two alternatives of mica tape the glass fabric and the mica paper stuck firmly together.

(C2) Mica tape with boron trichloride-trimethyl amine complex as the BX₃-amine complex

A mica paper sheet based on uncalcined mica flakes with an area weight of 160 g/m² was cut in a rectangular shape of the size 200×100 mm. For mica paper impregnation a solution of EP 455 in MEK was prepared which contained 1.5% of EP 455. The mica sheets were impregnated with 2.66 g of the solution. The solvent was removed in an oven at 110° C. for 1 min resulting in 2 g/m² EP 455. Additional, the mica sheets were impregnated either in the same step or in a second step with a consolidation resin. For the consolidation resin a 5% solution of polyol, polyester or modified polyester and/or polyol was prepared in MEK. The mica sheets were impregnated with 1.6 g of this solution. The solvent was removed in an oven at 120° C. for 3 min resulting in 4 g/m² consolidation resin (polyol, polyester or a modified polyester and/or polyol).

The treated mica paper was used in combination with the same glass fabric and in either of the two coating and adhering alternatives as described for (C1). Mica tapes were obtained which are designated in the following as (C2-1), with mica paper and glass fabric being polyester/polyol resin adhered, and (C2-2), with mica paper and glass fabric being solid epoxy resin adhered.

Again, in either of the two alternatives (C2-1) and (C2-2) the glass fabric and the mica paper stuck firmly together.

The above obtained mica tape specimens (C1-1), (C1-2), (C2-1) and (C2-2) were each cut in half to give two equal 100×100 mm sized samples.

Preparation of 4-Layered Composites with Inventive Mica Tapes and with Reference Mica Tapes and with Impregnation Resins, and Tests Thereof

Two 100×100 mm samples from (C1-1) and two 100×100 mm samples from (C1-2) were piled atop of each other with alternatingly 1.625 g evenly distributed impregnation resin after each mica tape layer, giving 4-layered mica tape composites with in each case having total resin weight of 6.5 g.

Analogously, four 100×100 mm samples of either a Zn naphthenate-containing mica tape (Poroband ME 4020) or of an accelerator-free mica tape (Poroband 0410) were piled atop of each other with alternatingly 1.625 g evenly distributed impregnation resin after each mica tape layer, giving two further 4-layered mica tape reference composites with in each case having total resin weight of 6.5 g.

The impregnation resins used and the designations of the resulting 4-layered composites, as used in the following tests, are indicated in Table 1.

TABLE 1

| | | Impregnation resin (wt % based on total resin) | | | | | |
|---|---|---|---|---|---|---|---|
| | | 3% DY 023 | | | | | |
| | | 5% GY 250; | 8% DY 023 | | | | |
| | | 20% PY 306; | 3% GY 250; | | | | |
| | | balance MY | balance MY | 20% PY | | MY 790- | |
| | | 790-1 CH; | 790-1 CH; | 306; | 100% | 1CH/HY | |
| | | (crystallisation- | (crystallisation- | balance | MY | 1102/DY | |
| | | free when | free when | MY 790- | 790-1 | 9577/DY | XD |
| | | molten) | molten) | 1 CH | CH | 073 | 4410 |
| Types | (C1-1) | (Inv I-1) | (Inv H-1) | (Inv G- | (Inv F- | | |
| of | and | [Inv bath I, DY | [Inv bath H, | 1) | 1) | | |
| mica | (C1-2) | 9577] | DY 9577] | [Inv bath | [Inv | | |
| tape | | | | G, DY | bath F, | | |
| | | | | 9577] | DY | | |
| | | | | | 9577] | | |
| | (C2-1) | (Inv I-2) | (Inv H-2) | (Inv G- | (Inv F- | | |
| | and | [Inv bath I, | [Inv bath H, EP | 2) | 2) | | |
| | (C2-2) | EP 455] | 455] | [Inv bath | [Inv | | |
| | | | | G, EP | bath F, | | |
| | | | | 455] | EP | | |
| | | | | | 455] | | |
| | Poroband | | | | | (Ref-1) | |
| | ME 4020 | | | | | | |
| | Poroband | | | | | | (Ref- |
| | 0410 | | | | | | 2) |

For further comparison purposes the impregnation resins used in above inventive impregnated 4-layered mica tape composites (Inv I-1) to (Inv F-2) were each also homogeneously mixed in the absence of mica tape with small amounts of either DY 9577 or EP 455 and cured in the absence of any mica tapes. The compositions of these further, mica-tape free reference formulations and their designations, as used in the following tests, are indicated in Table 2:

TABLE 2

| | | Impregnation resin (wt % based on total resin) | | | |
|---|---|---|---|---|---|
| | | 3% DY 023 | | | |
| | | 5% GY 250; | 8% DY 023 | | |
| | | 20% PY 306; | 3% GY 250; | 20% | |
| | | balance MY | balance MY | PY | |
| | | 790-1 CH; | 790-1 CH; | 306; | |
| | | (crystal- | (crystallisa- | balance | balance |
| | | lisation- | tion-free | MY | MY |
| | | free when | when | 790-1 | 790-1 |
| | | molten) | molten) | CH | CH |
| Homo- | 1.6% | (I-2) | (H-2) | | (F-2) |
| geneously | EP 455; | [Inv I] | [Inv H] | | [Inv F] |
| added | 2.0% | | | (G-2) | |
| acceler- | EP 455; | | | [Inv G] | |
| ator | 2.9% | | | (G-1) | (F-1) |
| | DY 9577 | | | [Inv B] | [Inv A] |
| | 3% | (I-1) | (H-1) | | |
| | DY 9577 | [Inv E] | [Inv D] | | |

The curing conditions for all samples were as follows:
Composites (Inv I-1), (Inv H-1), (Inv G-1) and (Inv F-1) with DY 9577: heating press; 100° C. at 20 bar for 4 h and then increasing the temperature to 170° C. at 20 bar for 10 h.
Composites (Inv 1-2), (Inv H-2), (Inv G-2), (Inv F-2) with EP 455: heating press; 125° C. at 20 bar for 4 h and then increasing the temperature to 170° C. at 20 bar for 12 h.
Reference composite (Ref-1): heating press; 160° C. at 20 bar for 12 h.
Reference composite (Ref-2): heating press; 125 ° C. at 20 bar for 4 h and then increasing the temperature to 170° C. at 20 bar for 12 h;
Reference formulation (H-2) with EP 455 and (H-1), (I-1) with DY 9577: heatable mould; 100° C. for 4 h and then increasing the temperature to 170° C. for 10 h;
Reference formulations (F-1), (G-1) with DY 9577: heatable mould; 100° C. for 4 h and then increasing the temperature to 170° C. for 12 h;

Reference formulations (I-2), (G-2), (F-2) with EP 455: heatable mould; 125° C. for 4 h and then increasing the temperature to 170° C. for 12 h.

All cured 4-layered composites and cured reference formulations were subject to the following tests:
1) Tan δ□ measurement according to IEC 60250 at 155° C. in Tettex instrument using a guard ring electrode at 400V/50Hz;
2) Glass transition temperature Tg. For the 4-layered composites according to IEC 61006 via DMA at 5°/min rate, using the temperature at which the maximal tan δ is observed as Tg; on 50 mm×10 mm specimens of the composites. For the reference formulations directly via DSC.

The cured 4-layered composites were furthermore analysed for the mass ratio of accelerator to cured organic content, by ashing at 700° C./15 min and comparing sample weight before and after ashing; on 50 mm×50 mm specimens of the composites. This ratio is R=m_{acc}/m_{bath} described in the general description.

The results of the above tests are summarised in below Table 3 (for the 4-layered inventive and reference composites) and in below Table 4 (for the corresponding reference formulations).

TABLE 3

| | | 4-layered composite | | | | | | | | | |
|---|---|---|---|---|---|---|---|---|---|---|---|
| | | | | (Inv I-1) | | | | | | | |
| | | (Ref-1) | (Ref-2) | [Inv bath | (Inv I-2) | (Inv H-1) | (Inv H-2) | (Inv G-1) | (Inv G-2) | (Inv F-1) | (Inv F-2) |
| | | [Comp | [Comp | I, DY | [Inv bath | [Inv bath H, | [Inv bath H, | [Inv bath G, | [Inv bath G, | [Inv bath F, | [Inv bath |
| | | A] | B] | 9577] | I, EP 455] | DY 9577] | EP 455] | DY 9577] | EP 455] | DY 9577] | F, EP 455] |
| Test | tan δ | 4.40% | 22.80% | 7.00% | 5.50% | 10.90% | 6.00% | 5.90% | 5.70% | 4.90% | 4.60% |
| | Tg (° C.) | 151.4 | 121.8 | 138.4 | 155.4 | 132.5 | 145.5 | 148.2 | 146.7 | 156.3 | 148.3 |
| | ratio R | — | — | 5.38:94.62 | 5.08:94.92 | 8.00:92.00 | 5.35:94.65 | 6.50:93.50 | 4.64:95.36 | 5.08:94.92 | 5.66:94.34 |

TABLE 4

| | | reference formulation | | | | | | | |
|---|---|---|---|---|---|---|---|---|---|
| | | (I-1) | (H-1) | (G-1) | (F-1) | (I-2) | (H-2) | (G-2) | (F-2) |
| | | [Inv E] | [Inv D] | [Inv B] | [Inv A] | [Inv I] | [Inv H] | [Inv G] | [Inv F] |
| Test | tan δ | 4.7% | 5.9% | 4.8% | 7.4% | 2.7% | 2.6% | 7.6% | 5.7% |
| | Tg (° C.) | 153/154 | 149/149 | 159/162 | 165/167 | 144/145 | 135/137 | 170/173 | 155.4 |

Conclusions based on the comparisons of inventive impregnated mica tapes with reference mica tapes and reference formulations

Firstly, all inventive 4-layered composites cured equally well as the corresponding impregnation baths with homogeneously admixed corresponding BCl₃ amine complex. This can be derived from the observed Tg values, which all are above about 130° C. They cure comparably well as the reference 4-layered composite (Ref-1) containing a Zn-naphtenate mica tape and furthermore homogeneously admixed BCl₃ amine complex. They cure better than the reference 4-layered composite (Ref-2) containing the standard one-component impregnation bath which contains a homogeneously dispersed highly latent curing accelerator.

Employing an impregnating resin bath consisting of essentially pure BADGE (distilled, n=0 to 0.3 in the formula of the general description) provides after curing the best tan δ values with either DY 9577 or EP 455 containing inventive mica tapes (see (Inv F-1) and (Inv F-2)), comparable to the reference 4-layered composite (Ref-1) containing Zn-naphthenate as accelerator.

Employing an impregnating resin bath consisting of essentially pure BADGE (distilled, n=0 to 0.3 in the formula of the general description) and 0 to about 20% by weight, based on the impregnating bath, of standard (unpurified) BFDGE, in combination with an inventive mica tape appears to give after curing in many cases better tan δ values than the same impregnation resin bath with the corresponding, but homogeneously admixed BCl₃ amine complex: See (Inv F-1) vs. (F-1), (Inv F-2) vs. (F-2), (Inv G-2) vs. (G-2).

The inventive systems match the requirements with the crystallizing resins with both accelerators DY 9577 and EP 455. Further the inventive impregnation systems and mica tapes with both accelerators match the requirements regarding tan δ and Tg values. The accelerators used according to the invention have a similar consolidating effect on the mica paper, as is known from the prior art accelerator zinc naphthenate, so that the need of further consolidating additives is not necessary.

The bath formulations for the vacuum pressure impregnation used in the inventive system can contain further epoxy resins besides BADGE to tune the tan δ and Tg values.

Any of the bath formulations for the vacuum pressure impregnation used in the inventive system can be stored at elevated temperature, such as 70° C., to avoid crystallisation even if the bath formulations for the vacuum pressure impregnation in question should have a tendency to crystallise when stored at room temperature.

The inventive mica tapes can tolerate in the BCl₃-amine complex contained therein variations in the chain length of R¹ contained therein: DY 9577 has chain length 8 and EP 455 has chain length 1. They can also tolerate variations of the content of BCl₃-amine complex (in g/m²) quite well with only minor effects on tan δ or Tg values. The tan δ and T_{g} values can however be controlled by appropriately choosing curing temperature and time.

What is claimed is:

1. An anhydride-free insulation system for current-carrying construction parts of an electric engine which comprises:
(A) a mica paper or mica tape for wrapping parts of said electric engine that are potentially current-carrying during operation of the engine, which mica paper or mica tape is impregnable via vacuum pressure impregnation with a thermally curable epoxy resin formulation and comprises a complex of boron trihalogenide with an amine of the formula
BX₃·NR¹R²R³ or R¹R²N—A—NR¹R²,
wherein X denotes halogen,
R¹, R² and R³ are each independently of the others hydrogen, C₁-C₁₂alkyl, C₅-C₃₀aryl, C₆-C₃₆aralkyl or C₆-C₁₄cycloalkyl, which can be unsubstituted or substituted by one or more C₁-C₁₂alkyl groups,
A is a bivalent aliphatic aromatic or cycloaliphatic radical;
(B) a thermally curable bath formulation for the vacuum pressure impregnation comprising bisphenol A diglycidyl ether and optionally bisphenol F diglycidyl ether,
which formulation is substantially or, preferably, entirely free of thermally activatable curing initiators for the epoxy resin formulation.

2. The insulation system according to claim 1, wherein the mica paper or mica tape comprises the complex of BCl₃ with a tertiary amine in an amount sufficient to cure the epoxy resin formulation taken up by the mica paper or mica tape and the construction part of the engine during the vacuum pressure impregnation step.

3. The insulation system according to claim 1 or 2, wherein the mica paper or mica tape (A) comprises the complex of BX₃ with a tertiary amine in an amount of about 0.01 to about 100 g/m² of the mica paper or mica tape, preferably about 2.0 to about 50 g/m², more preferably about 2.0 to about 20 g/m².

4. The insulation system according to any one of claims 1 to 3, wherein the complex of BX₃ with a tertiary amine is BCl₃·N(CH₃)₃ (boron trichloride-trimethyl amine complex) or BCl₃·N(CH₃)₂C₈H₁₇ (boron trichloride-dimethyl n-octyl amine complex).

5. The insulation system according to any one of claims 1 to 4, wherein the thermally curable bath formulation for the vacuum pressure impregnation (B) comprises, or consists essentially of, diglycidylethers of bisphenol A having the formula: 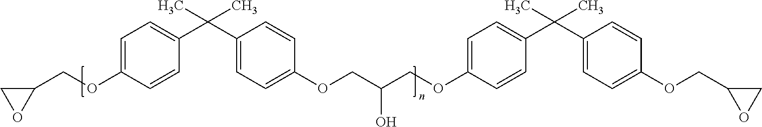
wherein n is a number equal or greater than zero, in particular 0 to 0.3, and represents an average over all molecules of the applied resin, and 0 to 20 wt % of bisphenol F diglycidyl ether, based on the weight of the bath formulation for the vacuum pressure impregnation (B).

6. The insulation system according to any one of claims 1 to 5, wherein the thermally curable bath formulation furthermore comprises one or more reactive diluents selected from the group consisting of a) polyglycidyl ethers derived from epichlorohydrin and phenolic compounds other than bisphenol A and bisphenol F, b) diglycidylethers derived from epichlorohydrin and acyclic alcohols and c) cycloaliphatic epoxy resins comprising at least two oxirane rings fused to a cycloaliphatic ring.

7. The insulation system according to claim 6, wherein the thermally curable bath formulation (B) comprises, or consists essentially of, diglycidylethers of bisphenol A, 0 to 30 wt % of diglycidylethers of bisphenol F and 2 to 10 wt % of the reactive diluents.

8. The insulation system according to any one claims 1 to 7, wherein the epoxy resin bath formulation has a viscosity of not more than about 75 mPa.s at 60° C., more preferably of not more than about 50 mPa.s at 60° C.

9. The insulation system according to any one of claims 1 to 8, wherein the thermally curable epoxy bath formulation (B) further comprises micro particles, nano particles or a mixture thereof, preferably nano particles, which particles are selected from metal or semi-metal oxides, carbides or nitrides, in particular from metal or semi-metal carbides or nitrides and, optionally, a wetting agent.

10. A mica tape which is impregnable via vacuum pressure impregnation with a thermally curable epoxy resin formulation, comprising a complex of BX₃ with a tertiary amine as defined in claim 1.

11. The mica tape according to claim 10, comprising the complex of BX₃ with a tertiary amine in an amount of about 0.01 to about 100 g/m² of the mica tape, preferably about 2.0 to about 50 g/m², more preferably about 2.0 to about 20 g/m².

12. The mica tape according to claim 10 or 11, comprising as the complex of BX₃ with a tertiary amine either BCl₃ N(CH₃)₃ (boron trichloride-trimethyl amine complex) or BCl₃ N(CH₃)₂C₈H₁₇ (boron trichloride-dimethyl octyl amine complex).

13. An use of an anhydride-free insulation system for current-carrying construction parts of an electric engine in form of a kit of parts as claimed in any one of claims 1 to 9 in the manufacture of rotors or stators of electrical generators or motors.

14. A process for using an anhydride-free insulation system for current-carrying construction parts of an electric engine as claimed in any one of claims 1 to 9 or a mica tape according to any one of claims 10 to 12 in the manufacture of rotors or stators of electrical generators or motors, wherein
(a) the potentially current-carrying parts of the rotor or stator or the construction part thereof are wrapped with a/the mica paper or mica tape which is impregnable via vacuum pressure impregnation with a thermally curable epoxy resin formulation and comprises a complex of BX₃ with a tertiary amine as defined in claim 1, which is contained by said mica tape in an amount sufficient to cure the epoxy resin taken up by the mica tape and the construction part of the engine during a vacuum pressure impregnation step,
(b) the rotor or stator or the construction part thereof is inserted into a container,
(c) the container is evacuated,
(d) a thermally curable bath formulation for the vacuum pressure impregnation as defined in claim 1, is fed into the evacuated container followed by a period of applying an overpressure e.g. of dry air or nitrogen to the container containing the rotor or stator or the construction part thereof, optionally under cautious heating in order to reduce the viscosity of the thermally curable bath formulation in the container sufficiently to allow that said formulation penetrates said mica tape and the gaps and voids existing in the structure of the rotor or stator or the construction part thereof within a desired time period forced by the pressure difference between the vacuum and the high pressure applied to the components,
(e) the residual thermally curable bath formulation is removed from the container, and
(f) the rotor or stator or the construction part thereof, impregnated with the thermally curable bath formulation, is removed from the container and heated after removal from the container in order to cure the thermally curable bath formulation comprised by said rotor or stator or the construction part thereof.

15. The process according to claim 14, wherein the thermally curable bath formulation (B) is fed into the evacuated container in step (d) from a storage tank and is returned to said to a storage tank again after removal from the container in step (e) and stored in the storage tank, optionally under cooling, for further use.
